(19) United States
(12) Patent Application Publication
(10) Pub. No.: US 2005/0150597 A1
(43) Pub. Date: Jul. 14, 2005

(54) Apparatus and method for controlled cleaving

(75) Inventors: Francois Henley, Aptos, CA (US); Hongbee Teoh, Saratoga, CA (US); Anthony Paler, San Leandro, CA (US); Albert Lamm, Suisun City, CA (US); Philip Ong, Milpitas, CA (US)

Correspondence Address: WAGNER, MURABITO & HAO LLP;Third Floor, Two North Market Street, San Jose, CA, 95113, US

(73) Assignee: Silicon Genesis Corporation, San Jose, CA (US)

(21) Appl. No.: 10/754,980

(22) Filed: Jan. 9, 2004

(51) Int. Cl. B32B 1/00

(52) U.S. Cl. 156/344; 156/584

(57) ABSTRACT

An apparatus and method for controlled cleaving is presented. Embodiments of the present invention include an apparatus for cleaving a substrate comprising a bottom shell coupled to a hinge mechanism, a top shell coupled to the hinge mechanism, a plurality of o-rings or suction cups coupled to the top and bottom shells for providing a suction force sufficient to exert a tensile force to the top and bottom of a substrate, a compliant member for sealing a portion of a grove edge of a substrate and for maintaining a pressure inside a volume formed between the groove edge and the groove edge of the substrate, a gas port for supplying gas to the volume, and a height adjustment mechanism coupled to the top shell and the bottom shell for separating the top shell from the bottom shell. One embodiment of the invention eliminates the use of gas system and is replaced by a blade edge to initiate propagation and applied tensile force of suction cups to apply tensile forces prior to initiation, control cleave process and maintain layer separation during and after cleaving.

### BACKGROUND OF THE INVENTION

1. Field of the Invention

The field of the invention relates to the manufacture of substrates. More specifically, embodiments of the present invention relate to an apparatus and method for controlled cleaving.

2. Related Art

Crafts people have been building useful articles, tools or devices using less useful materials for numerous years. In some cases, articles are assembled by way of smaller elements or building blocks. Alternatively, less useful articles are separated into smaller pieces to improve their utility. Examples of these articles to be separated include substrate structures such as a glass plate, a diamond, a semiconductor substrate, and others.

These substrate structures are often cleaved or separated using a variety of techniques. In some cases, the substrates can be cleaved using a saw operation. The saw operation generally relies on a rotating blade or tool, which cuts the substrate material to separate the substrate material into two pieces. This technique, however, is often extremely rough and cannot generally be used for providing precision separations in the substrate for the manufacture of fine tools and assemblies. Additionally, the saw operation often has difficulty separating or cutting extremely hard and/or brittle materials such as glass or diamond.

Accordingly, techniques have been developed to separate these hard and/or brittle materials using cleaving approaches. In diamond cutting, for example, an intense directional thermal/mechanical impulse generally causes a cleave front to propagate along major crystallographic planes, where cleaving occurs when an energy level from the thermal/mechanical impulse exceeds the fracture energy level along the chosen crystallographic plane.

In glass cutting, a scribe line using a tool is often impressed in a preferred direction on the glass material, which is generally amorphous in character. The scribe line causes a higher stress area surrounding the amorphous glass material. Mechanical force is placed on each side of the scribe line, which increases the stress along the scribe line until the glass material fractures, preferably along the scribe line. This fracture completes the cleaving process of the glass, which can be used in a variety of applications including households.

Although the techniques described above are satisfactory for the most part, as applied to cutting diamonds and glass material, they have severe limitations in the fabrication of small complex structures or precision work-pieces. For instance, the above techniques are often “rough” and cannot be used with great precision in fabrication of small and delicate machine tools, electronic devices, or the like. Additionally, the above techniques may be useful for separating one large plane of glass from another, but are often ineffective for splitting off, shaving, or stripping a thin film of material from a larger substrate. Furthermore, the above techniques may often cause more than one cleave front, which join along slightly different planes, which is highly undesirable for precision cutting applications. Other processing techniques such as using a release layer have had limited success. Such release layer techniques often require wet chemical etching, which is often undesirable in many state of art applications.

For instance, the semiconductor industry has attempted to improve upon conventional cleaving techniques to aid in the manufacturing of small electronic devices. In particular, a controlled cleaving process for separating layers of substrate material was desired and as a result, many new designs and processes have been provided. For example, a blade or knife device has been used to initiate cleaving between wafer layers. Prior Art FIG. 1A is an illustration of a process wherein a blade device 22 is used to initiate cleaving between bonded wafer one 20 and wafer two 21. Finished edges 25 and 26 form a gap 24 that guide the blade mechanism 22 between the two wafers. A force is then applied until the cleave initiates and begins to propagate.

Although often satisfactory, using a blade for the initiating process can result in some deleterious conditions. For example, many cleaving processes leave the cleaved wafer surfaces with a limited roughness and with loose particles that were broken during the cleaving operation. Under these conditions, surface damage can occur if the cleaved surfaces are allowed to contact each other after separation.

Prior Art FIG. 1B is an illustration of an enlarged cross-sectional view of a partially cleaved wafer stack. The wafer stack comprises wafer one 20 and wafer two 21 that are bonded together. As a result of the cleaving process, the surface on the inside of the cleave planes comprise peaks 27 and valleys 24. Many times, peaks 27 can be fractured, thus causing abrasion problems if the wafer surfaces come in contact again. Abrasions on the surfaces have deleterious effects on subsequent processes such as scratching, thus resulting in poor quality of the finished good.

From the above, it is seen that a technique for separating a thin film of material from a substrate which is cost effective and efficient is often desirable.

### SUMMARY OF THE INVENTION

Accordingly, the present invention provides an improved technique for removing a thin film of material from a bonded substrate using a controlled cleaving action. This technique allows an initiation of a cleaving process on a bonded substrate through the use of controlled energy and selected conditions to allow it to propagate through the substrate to remove a thin film of material from the substrate. The initiation of the cleaving process first applies a tensile force at the edge of a bonded (e.g., composite) substrate, and then an initiation force is applied between the substrate that initiates a cleaved region on a substrate. During cleaving there are at least two phases of separation. The first phase is the initiation and the second phase is the propagation of the cleave front. This two phase separation sequence is controlled through programmed acceleration and velocity profiles of separation distance of the substrate edges. In addition, the present invention provides a cleaving apparatus and method that does not allow the thin film to contact the composite substrate after cleaving, thus reducing deleterious effects such as scratching.

An apparatus and method for controlled cleaving is presented. Embodiments of the present invention include an apparatus for cleaving a bonded substrate comprising a bottom shell coupled to a hinge mechanism, a top shell coupled to the hinge mechanism, a plurality of o-rings or suction cups coupled to the top and bottom shells for providing a suction force sufficient to exert a tensile force to the top and bottom of a substrate. One embodiment for initiation is a compliant member for sealing a portion of a grove edge of a bonded substrate and for maintaining a pressure inside a volume formed between the groove edge and the groove edge of the substrate, a gas port for supplying gas to the volume, and a height adjustment mechanism coupled to the top shell and the bottom shell for separating the top shell from the bottom shell. In another embodiment of the invention, a blade edge is used to initiate propagation.

Embodiments of the present invention also include a method for initiating and cleaving a bonded substrate comprising of placing the bonded substrate on the bottom cleaving shell, then placing the top cleaving shell on the other side of the bonded substrate, the substrate comprising a first perimeter edge and a second perimeter edge, to compress and seal a compliant member against the first perimeter edge and the second perimeter edge of the substrate to form a selected volume, pressurizing the selected volume with a gas, wherein the gas is at a pressure capable of initiating a cleave front in the substrate, and providing a separating force substantially perpendicular to the cleave front. In addition, tensile forces are also applied from vacuum to the top and bottom shells to maintain separation of the cleave which prevents the substrate from touching after cleaving. In another embodiment of the invention, a blade edge is used to initiate propagation. In this embodiment of the invention, an electrically controlled motor coupled to a hinge mechanism controls the acceleration and velocity of the cleave front across the substrate.

These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

Prior Art FIG. 1A is an illustration of a conventional cleaving process wherein a blade mechanism is used to initiate and propagate cleaving.

Prior Art FIG. 1B is a side view of the surface finish of a conventional cleaving process wherein the surface finish comprises peaks and valleys.

FIG. 2 is a logical block diagram of an exemplary computer system in accordance with an embodiment of the present invention.

FIG. 3A is a simplified cross section of an exemplary composite substrate with two edge-finished wafers bonded together in accordance with an embodiment of the present invention.

FIG. 3B is a simplified cross section of an exemplary composite substrate with one edge-finished wafer and one flush-edged wafer bonded together in accordance with an embodiment of the present invention.

FIG. 3C is a simplified cross section of an exemplary composite substrate with two flush-edged wafers bonded together in accordance with an embodiment of the present invention.

FIG. 4A is a simplified side view of an exemplary cleaving apparatus with a bonded pair fixed in the chuck prior to cleaving in accordance with an embodiment of the present invention. The initiation and lid separation mechanisms are independent of each other.

FIG. 4B is a simplified side view of an exemplary cleaving apparatus with a bonded pair partially cleaved in accordance with an embodiment of the present invention.

FIG. 4C is a simplified side view of an exemplary cleaving apparatus with a bonded completely cleaved in accordance with an embodiment of the present invention.

FIG. 5A is a simplified top view of a portion of an exemplary wafer cleaving system illustrating the details of a gas port and edge seal in accordance with an embodiment of the present invention.

FIG. 5B is a simplified cross section of a portion of an exemplary wafer cleaving apparatus with a substrate disposed in the tool in accordance with an embodiment of the present invention.

FIG. 5C is a cross section of an exemplary o-ring with a bent gas delivery tube in accordance with an embodiment of the present invention.

FIG. 5D is a flow diagram of the steps performed in an exemplary cleaving process in accordance with an embodiment of the present invention.

FIG. 6 is a top view of an exemplary cleaving tool illustrating a plurality of o-rings or suction cups used to provide tensile force to the composite substrate during cleaving in accordance with an embodiment of the present invention, top and bottom cleave shells.

FIG. 7 is a top view of an exemplary cleaving apparatus illustrating an expanding cleave front in accordance with an embodiment of the present invention.

FIG. 8A is a simplified cross section of an exemplary o-ring and gas delivery tube with a tubing retainer in accordance with an embodiment of the present invention.

FIG. 8B is a simplified cross section of an exemplary o-ring with a tube retainer collet in accordance with an embodiment of the present invention.

FIG. 8C is a simplified cross section of a portion of an exemplary wafer cleaving tool comprising an alternative embodiment of an o-ring in accordance with an embodiment of the present invention.

FIG. 9 is a flow diagram for the steps performed during an exemplary cleaving process wherein the cleaved layer does not contact the composite substrate after cleaving in accordance with an embodiment of the present invention.

FIG. 10a is an illustration of an exemplary apparatus in a closed position for controlled cleaving in accordance with embodiments of the present invention.

FIG. 10b is an illustration of an exemplary apparatus in an open position for controlled cleaving in accordance with embodiments of the present invention.

FIG. 11 is a flow diagram of an exemplary process for controlled cleaving in accordance with embodiments of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

### Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “sensing,” “controlling,” “scanning,” “receiving,” “sending,” “sensing,” “monitoring,” or the like, refer to the action and processes (e.g., processes 900 and 1100) of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

U.S. Pat. Nos. 6,155,909, 6,221,740, 6,23,941, 5,994,207, 6,013,567, 6,013563, 6,033,974, 6,284,631, 6,291,313 are incorporated herein by reference as foundation for the present invention.

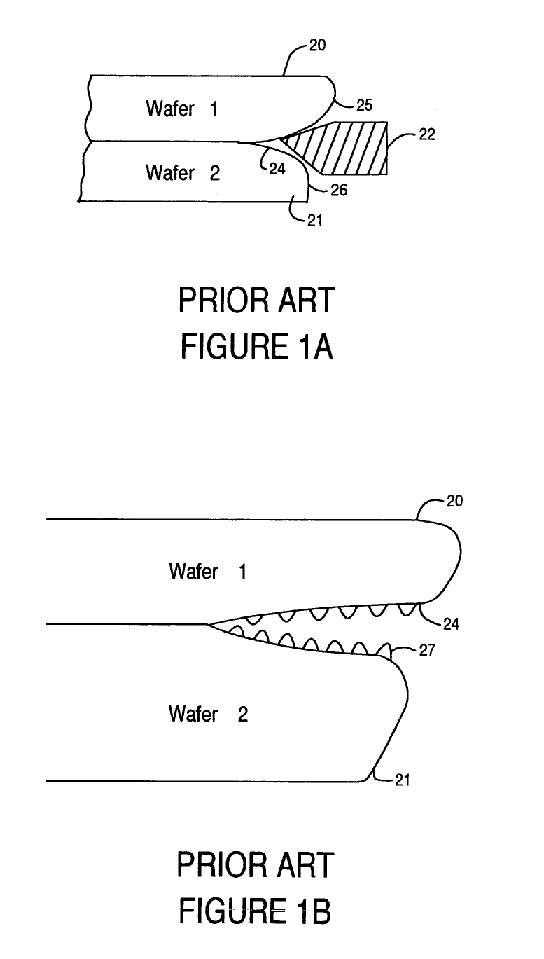

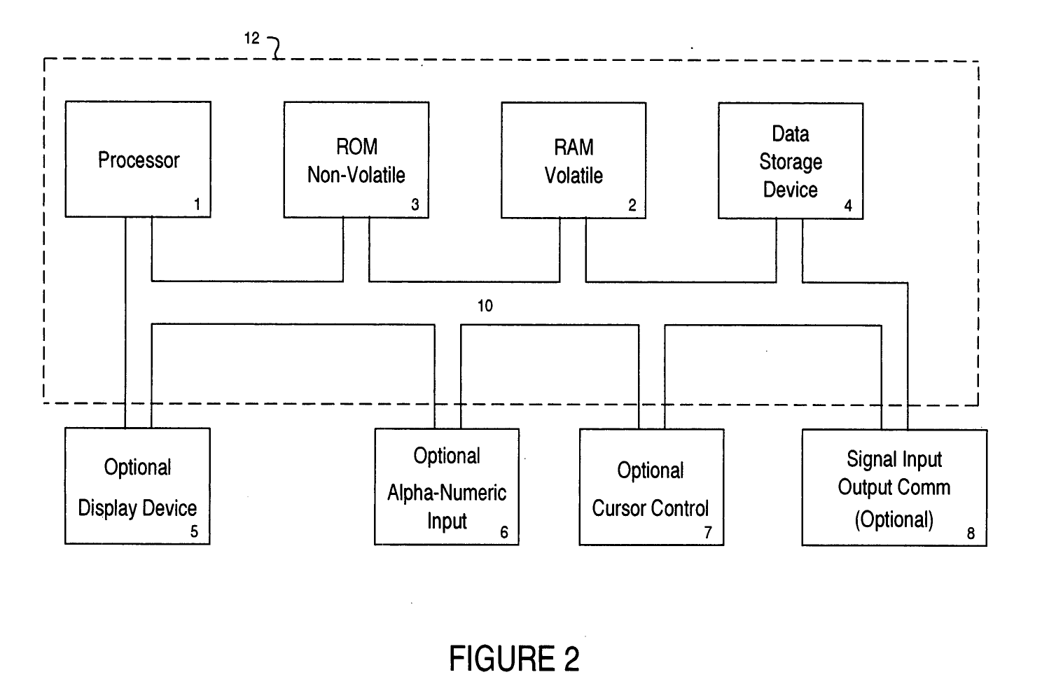

Referring now to FIG. 2, a block diagram of exemplary computer system 12 is shown. It is appreciated that computer system 12 of FIG. 2 described herein illustrates an exemplary configuration of an operational platform upon which embodiments of the present invention can be implemented. Nevertheless, other computer systems with differing configurations can also be used in place of computer system 12 within the scope of the present invention. For example, computer system 12 could be a server system, a personal computer or an embedded computer system such as a computer control module. In one embodiment of the present invention, exemplary computer system 12 is used to monitor and control a cleaving process using various inputs from sensors and regulators.

Computer system 12 includes an address/data bus 10 for communicating information, a central processor 1 coupled with bus 10 for processing information and instructions, a volatile memory unit 2 (e.g., random access memory, static RAM, dynamic RAM, etc.) coupled with bus 10 for storing information and instructions for central processor 1 and a non-volatile memory unit 3 (e.g., read only memory, programmable ROM, flash memory, EPROM, EEPROM, etc.) coupled with bus 10 for storing static information and instructions for processor 1. Computer system 12 may also contain an optional display device 5 coupled to bus 10 for displaying information to the computer user. Moreover, computer system 12 also includes a data storage device 4 (e.g., disk drive) for storing information and instructions.

Also included in computer system 12 of FIG. 2 is an optional alphanumeric input device 6. Device 6 can communicate information and command selections to central processor 1. Computer system 12 also includes an optional cursor control or directing device 7 coupled to bus 10 for communicating user input information and command selections to central processor 1. Computer system 12 also includes signal communication interface 8, which is also coupled to bus 10, and can be a serial port. Communication interface 8 can also include number of wireless communication mechanisms such as infrared or a Bluetooth protocol.

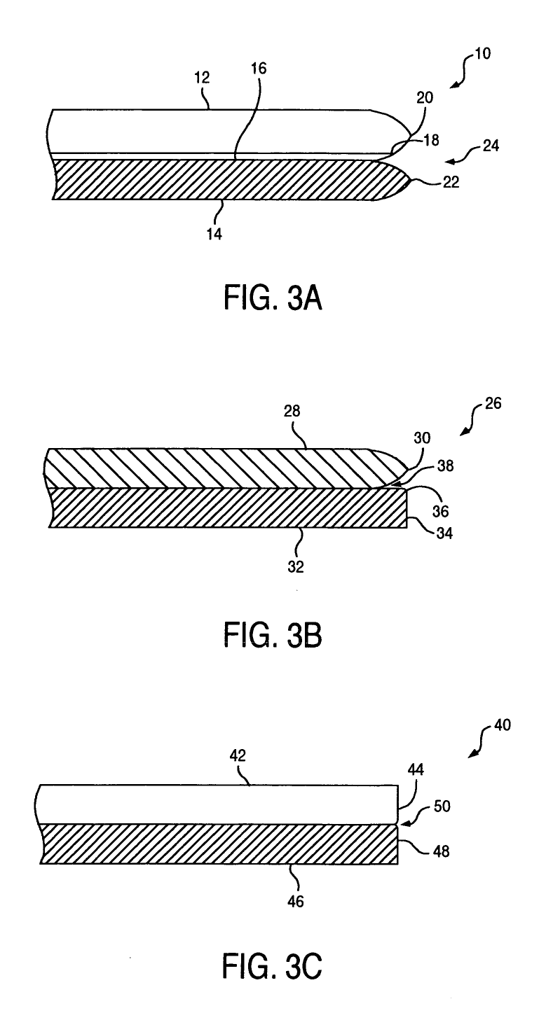

FIG. 3A is a simplified cross section of a portion of a bonded (e.g., composite) substrate 10 formed from a first wafer 12 bonded to a second wafer 14 at an interface 16. The first wafer has a stressed layer 18, which may have been formed by implanting protons or other particles (e.g., hydrogen, deuterium, etc.) at a selected depth and concentration, using a plasma immersion ion implantation, beamline ion implantation, or diffusion process, for example. The first wafer 12 has a finished edge 20 in the approximate shape of a truncated cone with rounded edges. The second wafer 14 also has a finished edge in the shape of a bullet nose. The shapes of the wafer edges are given as examples only, and illustrate that a perimeter groove 24 forms between wafers with finished edges. The perimeter groove typically extends essentially around the substrate and the depth of the groove typically being greater than the wafer alignment error that typically occurs during bonding. Also, the design of the o-ring (e.g., suction cup) allows for misalignment. In one embodiment the stress layer is incorporated on the second wafer 14 instead of the first wafer 12.

FIG. 3B is a simplified cross section of a portion of a composite substrate 26 formed from a first wafer 28 having a finished edge 30 and a second wafer 32 having a flush edge 34. The edge of the second wafer has not been shaped in a separate edge finishing process; however, an artifact of a polishing process has left the corner 36 slightly rounded. The mating surfaces of the wafers that are bonded together to form a composite substrate are often polished to provide intimate surface contact in the bonding process. A perimeter groove 38 also forms between a wafer with a finished edge bonded to another substrate.

FIG. 3C is a simplified cross section of a portion of a composite substrate 40 formed from a first wafer 42 having a flush edge 44 and a second wafer 46, also having a flush edge 48. A relatively small notch 50 forms between the wafers as a result of the corner-rounding that occurred during the polishing process; however, this notch may not extend around the perimeter of the composite substrate, depending on the alignment of the wafers to each other.

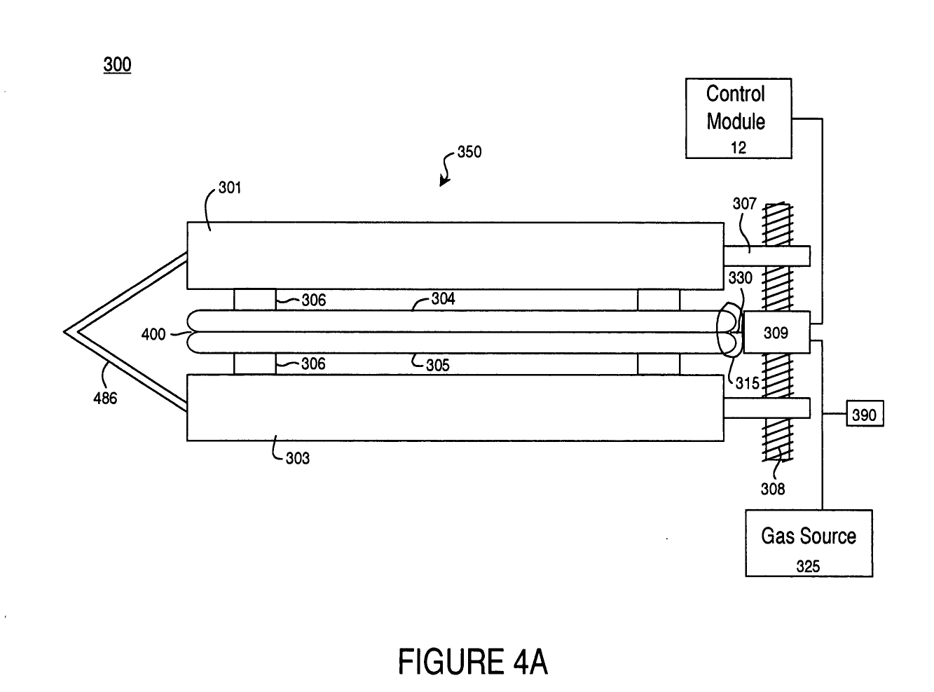

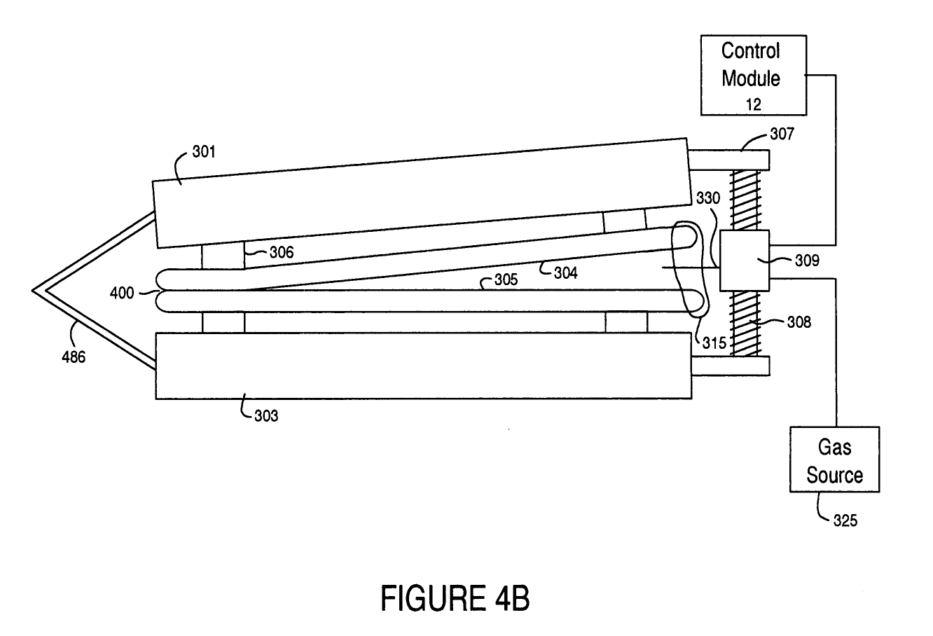

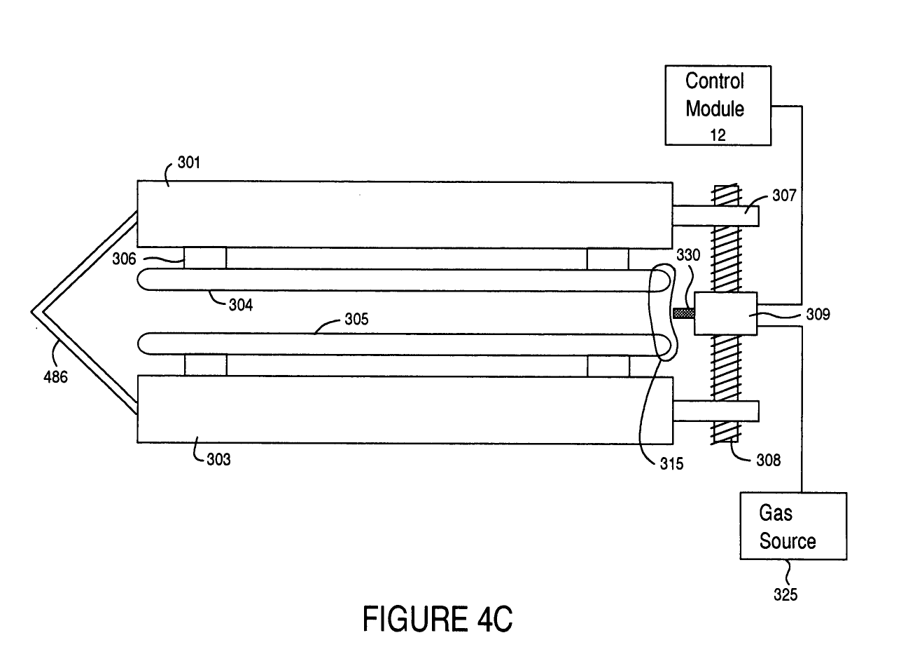

FIG. 4A is a simplified representation of an apparatus 300 for separating thin films of material from composite substrates. A cleave tool 350 has a base shell 303 and a top shell 301 that can be separated (e.g., by lifting off or by a hinge mechanism) in order to load tensile force on a composite substrate 400 that comprises a first wafer 304 bonded to a second wafer 305. The base shell 303 is fabricated from a hard material such as tooling plate (cast Al—Zn alloy) or other metal. The top shell 301 has a hard, rigid cap 301 and compliant o-rings or suction cups 306. The cap is fabricated from tooling plate while the o-rings 306 are made from compliant material suitable for maintaining a suction force on a substrate material. The o-rings or suction cups support and lift the substrate during the cleaving process. The o-rings or suction cups allow the composite substrate to expand slightly to separate the composite substrate 400 and transfer a thin film from the donor substrate to the handle substrate.

An o-ring (e.g., suction cup) 315 forms a seal around a portion of the perimeter edges of the composite substrate 400. It is appreciated that the o-ring 315 may also be a suction cup device and may also use a vacuum force to provide suction. The o-ring is hollow and operates at ambient (atmospheric) pressure to provide compliance, but could be sealed and pressurized to control the compliance and sealing force, or could be solid. A gas port 330, in this case, formed by a needle extending through o-ring 315, provides a burst, bursts or a steady flow of gas to a perimeter plenum formed by the sealed edge groove of the composite substrate. The o-ring 315 does not have to seal the entire perimeter of the composite substrate, such as if the composite substrate has an alignment feature such as a flat side or sides.

Gas is provided from a gas source 325, such as a dry nitrogen source, but could be other types of gas such as air, helium, or argon. The gas flow is controlled by a solenoid valve 390, or similar valve, that is coupled to a control module 12 which controls the gas supplied to the gas port 330. In one embodiment of the present invention, the gas source provides gas at a nominal pressure of about 300 PSI (pounds per square inch). In one embodiment of the invention, the pressure can be upwards of 3,000 PSI. The burst of gas is usually sufficient to initiate cleaving between the composite substrate. Gas may be lost through leakage between the o-ring and the substrate, especially where the o-ring does not form a seal with the substrate. Beneficially, gas loss increases as cleaving propagates across the substrate plane. The gas loss allows for a controlled cleave process that does not propagate too quickly, and in addition, cleaving stops when the pressure drops below the point to continue propagation. The pressure loss can be monitored and controlled by the control module 12. Control module 12 controls the gas solenoid 390 and monitors the gas loss between the o-ring and the substrate. To aid in controlling the cleave process, the control module 12 turns off the gas supply when a predetermined pressure loss is detected.

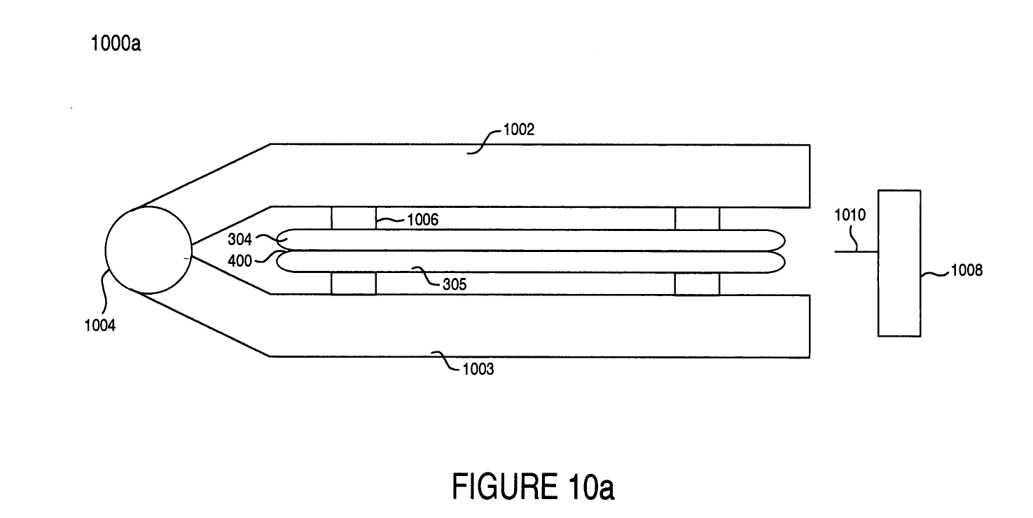

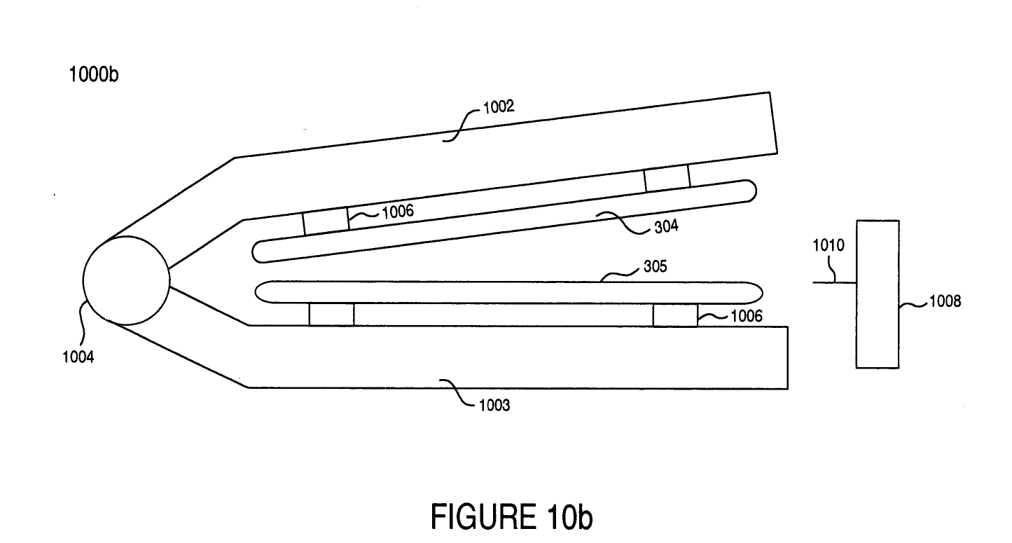

A lifting mechanism 309 is included to provide a tensile force to the composite substrate and for separating the layers after the cleaving process is completed. Lifting mechanism 309 can be a stepper motor that controls a screw shaft 308 or any other comparable mechanism suitable for separating the composite substrate after cleaving and for providing a tensile force during the cleaving process, for example, a servo motor or any other electrically controlled motor device. A connecting member 307 connects the top lid 301 and the bottom support to the screw shaft 308. In one embodiment of the present invention, when the stepper motor 309 turns the screw shaft 308, the top and bottom begin to separate from each other, thus providing tensile force to the composite substrate 400. In one embodiment of the invention, a hinge mechanism is used in conjunction with an electrically controlled motor to provide the tensile force used to separate the substrate 400. Examples of the hinge mechanism and electrically controlled motor are illustrated and described in FIG. 10.

FIG. 4B is a simplified representation of an apparatus 300 for separating thin films of material from composite substrates. In FIG. 3B, the lifting mechanism 309 has separated the composite substrate 400 and the wafer layers are partially cleaved. The gap between the two layers has been exaggerated for illustrative purposes to depict how the layers are separated. As the layers are separated the pressure loss increases until the cleaving process stops. The pressure loss through the gap ensures a controlled cleaving process.

FIG. 4C is a simplified representation of an apparatus 300 for separating thin films of material from composite substrates. In FIG. 4C, the wafer has been completely cleaved and separated from the composite substrate. The cleaving process uses the o-rings 306 or, for example, suction cups, to ensure the wafer does not contact the composite substrate after it has been cleaved, thus eliminating the deleterious effects of foreign particles that can scratch the surface finish of the wafer after cleaving.

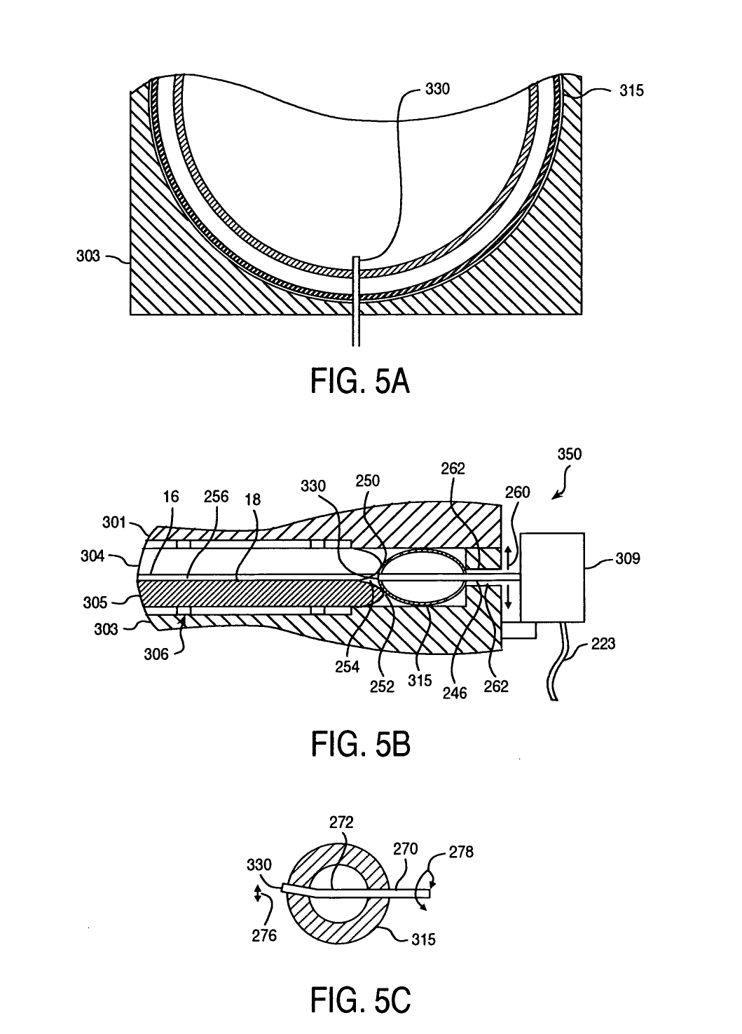

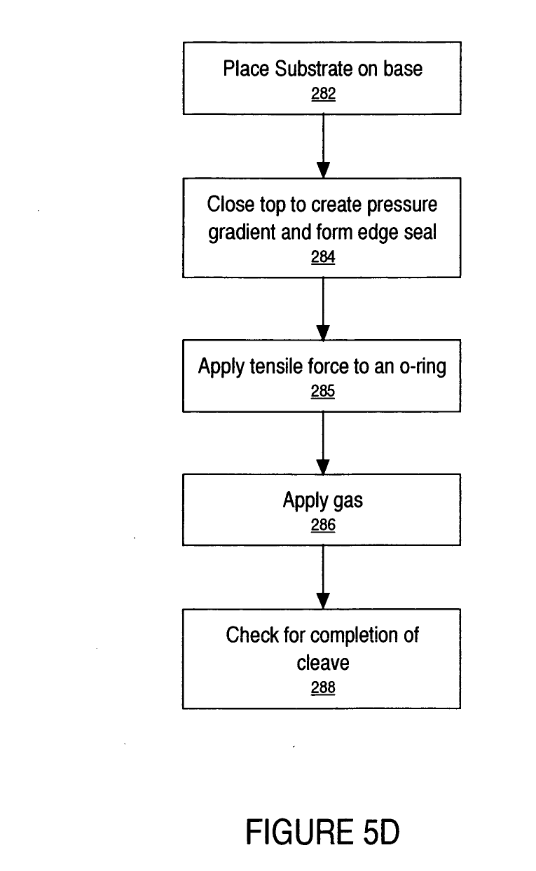

FIG. 5A is a simplified top view representing the base 303 and the o-ring 315, which is shown as sectioned. The gas port 330 is the outlet of needle like tubing, such as the tubing used to make hypodermic needles. In one embodiment of the invention, the tubing is made of type 316 stainless steel with an internal diameter of about 0.010 mm and an outer diameter of 0.5 mm. The gas port extends approximately 10 mils through the o-ring. In one embodiment, a needle is used to make a hole in the o-ring for the gas port to pass through.

FIG. 5B is a simplified cross view of a portion of cleaving tool 350 showing further details of the o-ring 315, composite substrate layers 304 and 305, and gas port 330. The inside diameter of the o-ring is slightly larger than the diameter of the composite substrate, allowing the composite to be easily placed onto the base 303 of the cleave tool 350. When the top 310 is assembled to the base 303 of cleaving tool 350, the o-ring 315 is compressed, moving the gas port 330 toward the center of the substrate and contacting the first edge 250 and the second edge 252 of the composite substrate to seal the edge groove and form a plenum 254. The gas port 330 is situated within the plenum 254 to pressurize the plenum, thus creating forces to separate the first substrate 304 from the second substrate 305. If the weakened layer 18 is weaker than the bonding interface 16, the composite substrate cleaves at the weakened layer and transfers a thin film 256 of the first substrate 304 to the second substrate 305.

A height adjustment mechanism 309 is provided to accurately align the gas port 330 with the edge groove/plenum. In addition, the height adjustment mechanism 309 applies a tensile force to the composite substrate and ensures the wafers do not contact each other after cleaving. The height adjustment mechanism 309 moves along with the gas port 330 and tubing, relative to the top/base of the cleave tool, as represented by the arrows 260. Alignment accuracy is achieved with a stepper motor that can be controlled with a control module, such as control module 12 of FIGS. 4A-4C. The gas line 223 to the height adjustment mechanism 309 is flexible to allow for the height adjustment. Similarly, via 262 through the base 303 is larger than the tubing diameter, and may be an oversized hole or slot.

FIG. 5C is a simplified cross section showing further refinement of the tubing and gas port or fluid port. The tubing 270 has a slight bend 272, of between about 5-15 degrees that is about 3 mm back from the gas port 330, so that the bend is occurs within the interior of the o-ring 315. This allows vertical alignment of the gas port 330, represented by the arrows 276, by rotating the tubing 70, by itself or in conjunction with the height adjustment mechanism 309 from FIGS. 4A-4C. Rotating the tubing also allows an operator to confirm the gas port is within the edge groove by providing tactile feedback as the gas port contacts one edge upon rotation in one direction, and then the other edge as the rotation is reversed.

FIG. 5D is a simplified flow chart representing a process 280 according to an embodiment of the present invention. After placing a substrate on the base in step 282, the top is closed in step 284, which compresses the o-ring against the substrate. The top is closed in a fashion to apply a greater force against the substrate in the regions further from the gas port. In an embodiment of the present invention, closing the top also compresses the perimeter O-ring to form a seal with at least a portion of the perimeter of the substrate.

Next, in step 285, vacuum is applied to an o-ring as to allow the height adjustment mechanism to apply a tensile force to the substrate. Next, a burst of gas is applied to a region on the perimeter of the substrate in step 286. Once cleaving has initiated, the height adjustment slowly lifts the top wafer from the bottom wafer substrate. By applying the tensile force in step 285, the wafers do not come in contact again after cleaving has been completed. If the substrate cleaving tool has a cleave indicator, the substrate is then checked for completion of the cleave in step 288. If the cleave is complete, the process can stop in step 290). If the cleave is not complete, another burst of gas may be applied. The subsequent burst of gas may be of the same duration and pressure, or of a different duration and/or pressure than the initial burst of gas. It is noted that some substrates are easier to cleave than others, depending on the type of material and pre-cleave treatment (e.g. implant species, dosage, and energy), and that some cleave processes may be consistent and reliable enough to be performed without a cleave indicator.

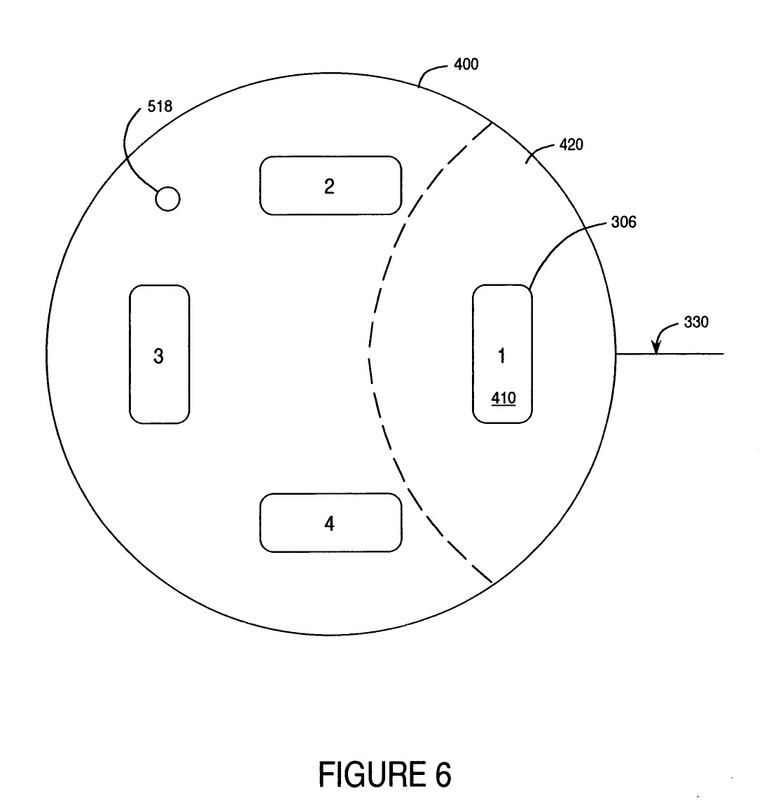

FIG. 6 is a top view of a composite substrate coupled to a plurality of o-rings (e.g., suction cups) used to provide a tensile force for separating layers during and after a cleaving process and provide sufficient tensile force to keep the separated layers from touching at any point of the cleaving process.

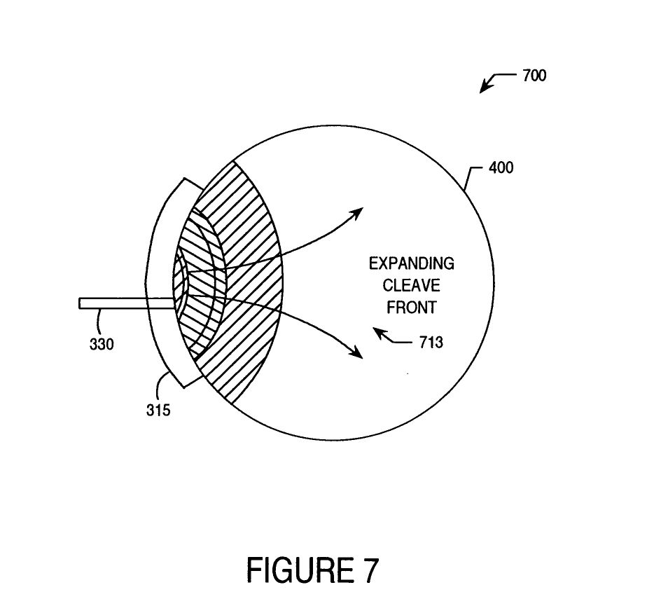

FIG. 7 is a top view illustration showing a cleave propagation on a composite substrate. In one embodiment of the present invention, controlled cleaving is accomplished using an o-ring 315 that allows leakage as a cleave is propagated. For example, as mentioned above, an o-ring 315 seals the groove edge of a wafer 400 and provides a cavity that can be pressurized to initiate a cleave. Once cleaving is initiated, the cleave front expands toward the middle of the wafer 713. As the cleave front expands beyond the o-ring edge, leakage around the edge of the o-ring lowers the pressure on the cleave front, thus slowing and controlling the cleave. As shown in FIG. 7, the gas port 330 is directed at an edge of a substrate to remove the material layer from the substrate. The expanding cleave front propagates slightly beyond the edge of the o-ring 315. In one embodiment of the present invention, the distance the cleave front expands beyond the o-ring is controlled by a control module 12 of FIGS. 4A-4C.

This provides a differential pressure across the substrate. A differential pressure is desirable because of the nature of cleave initiation and propagation. In most materials of interest, cleaving is essentially a stressed fracture. The energy required to initiate such a fracture may be lowered by providing a local mechanical defect, such as a crack or scratch. Thus, once the cleave is initiated in the low pressure region (near the gas port), higher pressure may be applied to the substrate to keep the cleaved halves from “jumping” and potentially breaking across the face of the half. A sensor, represented by circle 518, is placed near the flat of the substrate to determine if the cleave has propagated through the substrate, as discussed above. Alternatively, a constant pressure may be applied, depending on the type of material(s) the substrate is made of, the thickness of the cleaved halves, and the pressure and duration of the gas being applied, and other factors.

A pressure gradient may be important to prevent some composite substrates from flying apart and breaking when cleaved, while allowing cleaving to form and propagate. It is believed the combination of the applied pressure gradient and the compliant pad in the top and bottom shells allow the efficient cleaving of composite substrates while avoiding breakage, especially of the donor substrate. It is recognized that other combinations of compliant pads and pressures may obtain similar results, and that different pressures and pressure gradients may be appropriate for different materials or cleave conditions. Similarly, the force may be applied between the top shell and the bottom shell by a variety of mechanisms, such as pre-set springs, weights, gas or hydraulic cylinders, or even a compliant pad with a graded durometer, the durometer being less near the gas port, where the cleave is initiated.

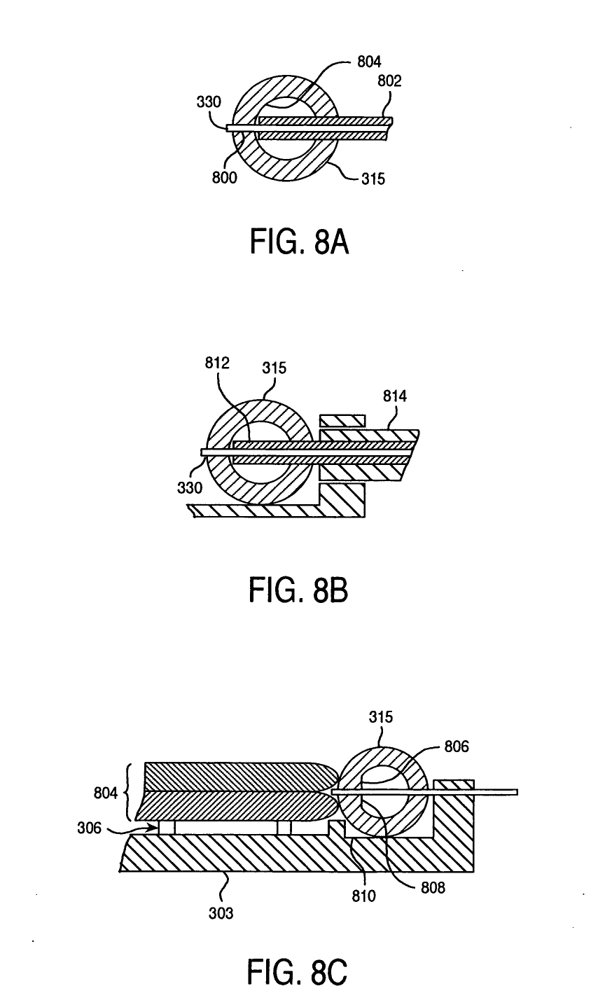

FIG. 8A is a simplified cross section of fine tubing 800 supported by a tubing retainer 802. The tubing retainer is co-axial with the fine tubing, and is a section of drilled metal rod, for example, glued to the tubing, but could be other material, such as plastic. The tubing retainer 802 supports the fine tubing 800 to the interior surface 804 of the O-ring 315, thus increasing the stiffness of the tubing assembly and allowing for better height control of the gas port 330, as well as better durability, and the option of using finer and/or thinner-walled tubing.

FIG. 8B is a simplified cross section of fine tubing 800 supported by a tubing retainer 812, which is further supported by a retainer collet 814. The retainer collet provides additional stiffness to the tubing assembly, and allows sub-assemblies of fine tubing and tubing retainers to be manufactured in anticipation of rapid exchanging of gas ports for maintenance or to configure the cleave system for different substrates. In lieu of a retainer collet, a tubing retainer with a stepped diameter may be manufactured, either out of a single piece of rod, for example, or assembled from multiple pieces.

Although the above injector has been described in terms of tubing, it an also be may other means for supplying gas and/or fluid to the system. Here, the means can include, among others, almost any suitable member that directs fluid into the system. The member can be shaped in a variety of configurations such as a rectangle, a semicircle, or other shape, which is suitable for directing the fluid into the system. The end of the means can be flared, pointed, or any other shape suitable for supplying the fluid. One of ordinary skill in the art would recognize many other variations, alternatives, and modifications.

FIG. 8C is a simplified cross section of a portion of a cleave tool showing alternative embodiments for the O-ring 315 and the bottom shell 303. The outer diameter of the O-ring is substantially greater than the thickness of the composite substrate. Additionally, the O-ring does not have a constant thickness, but rather has a thicker section 806 near the gas port. The thicker section of the O-ring where the O-ring will contact the substrate to form an edge seal improves the contact force and stiffens the side of the plenum formed by the O-ring. An O-ring groove 810 is provided in the bottom shell, and a similar groove may be provided in the top shell (not shown), or the top shell may be flat.

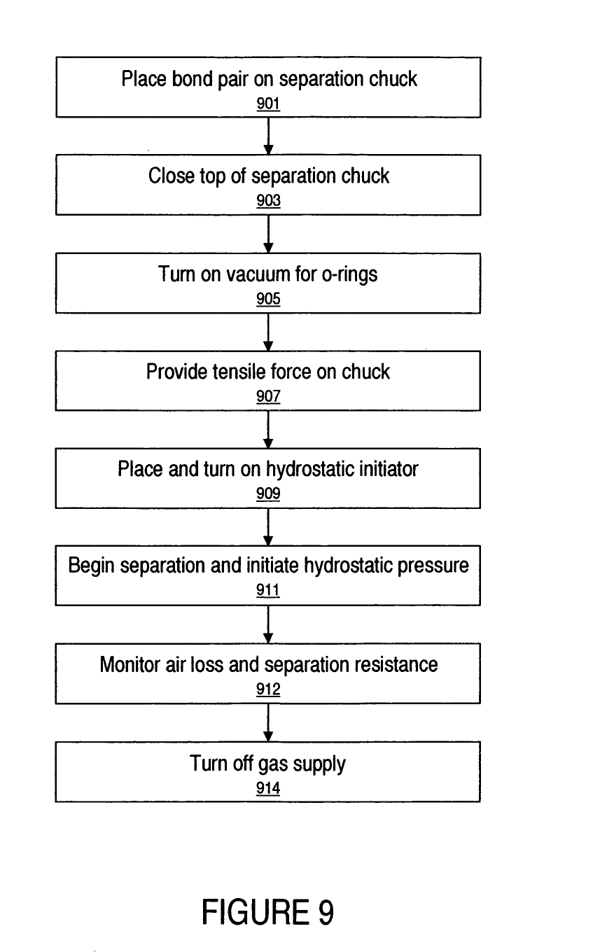

FIG. 9 is a simplified flow diagram illustrating the process of separating a bond pair substrate in accordance with an embodiment of the present invention. The first step 901 is to load a bond pair wafer into the separation chuck. The next step 903 is to close the chuck and secure the top of the chuck to the base of the separation chuck. Then in step 905, a vacuum is applied to all o-rings. Then in step 907 a tensile force is applied to the bond pair by suction and/or separating the top of the separation chuck from the bottom using the height control mechanism mentioned above. In one embodiment of the invention, a sensor monitors the tensile force applied to the bond pair and uses the force measurement to control the height adjustment mechanism to keep the force within predetermined parameters to achieve a controlled cleave. The next step 909 is to turn on the hydrostatic initiator. The gas source is regulated by a pressure sensor and a solenoid valve that is controlled by control module 12 as mentioned above. In the next step 911, the height adjustment mechanism begins to apply a tensile force on the composite substrate and air pressure is applied to the volume created between the groove edge and the o-ring. In step 912 the control module monitors the pressure loss in conjunction with the tensile force applied to the bond pair to regulate the gas flow and the height adjustment mechanism. In step 914, the gas supply is turned off after cleaving. Lastly, in step 916, the remaining O-rings supply a vacuum force to help separate the cleaved film from the substrate. In one embodiment of the invention, a blade is used to initiate propagation.

FIG. 10a is an illustration of an exemplary cleaving apparatus 1000a for controlling cleaving in a closed position in accordance with embodiments of the present invention. The cleaving apparatus 1000a uses an electrically controlled motor 1004 to control the position of the movable top 1002 in relation to the position of the fixed bottom 1003. In one embodiment of the invention, the top 1002 pivots at the electrically controlled motor 1004 to propagate a cleave between a top layer 304 and a bottom layer 305 of a substrate. In one embodiment of the invention, a cleave initiation device 1008 is used to initiate a cleave 400 in the substrate. In one embodiment of the invention, a blade 1010 is used to strike the substrate approximately parallel to the planar surface of the substrate. Suction cups 1006 couple the substrate to the top 1002 and bottom 1003 of the cleaving apparatus 1000a and provide a tensile force to separate the layers 304 and 305 of the substrate.

After the cleave is initiated, the electrically controlled motor 1004 provides a force to pivot the top 1002 and provides a tensile force to the top 304 and bottom 305 of the substrate to propagate the cleave across the planar surface of the substrate. In one embodiment of the invention, the acceleration and velocity of the cleave front can be controlled by the electrically controlled motor 1004. In one embodiment of the invention, a computer or logic controller provides movement instructions to the motor 1004. In this embodiment of the invention, a cleave position sensor and/or force sensor can be used to determine the position, velocity and acceleration of the cleave front which is used to control the motor 1004. In another embodiment of the invention, the position of the cleave front can be determined from the angle between the top 1002 and the bottom 1003 at the electrically controlled motor 1004.

FIG. 10b is an illustration of an exemplary cleaving apparatus 1000b in an open position in accordance with embodiments of the present invention. FIG. 10b illustrates the cleaving apparatus 1000b in an open position after cleaving is complete. In one embodiment of the invention, once cleaving is completer, the layers 304 and 305 of the substrate are prevented from contacting each other. The suction cups 1006 hold the layers 304 and 305 to the top 1002 and bottom 100, respectively. By preventing the layers 304 and 305 from coming in contact after cleaving, the surface finish is greatly improved.

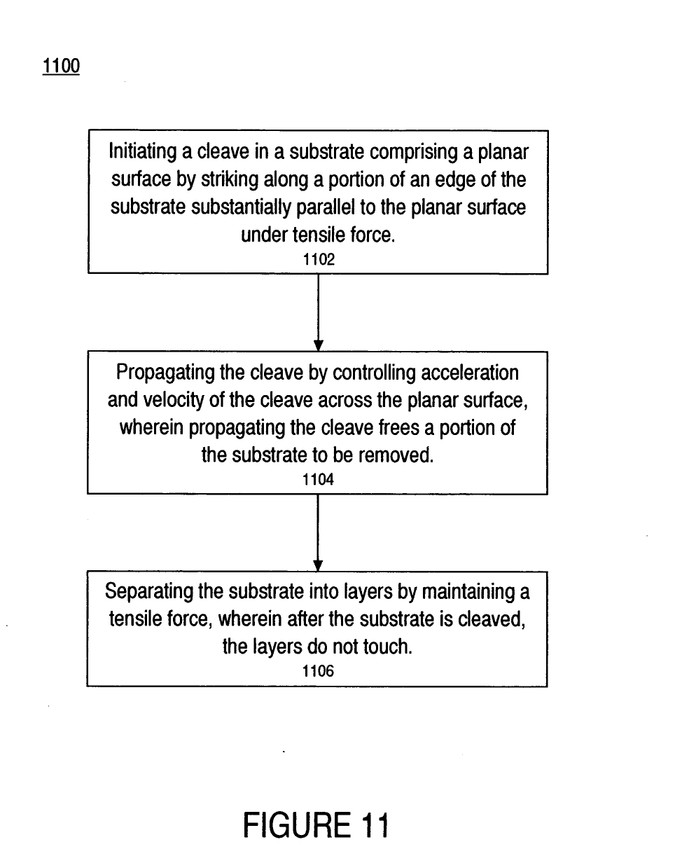

FIG. 11 is a flow diagram of an exemplary process 1100 for controlling cleaving in accordance with embodiments of the present invention. In one embodiment of the present invention, the acceleration and velocity of cleave propagation across the plane of a substrate is controlled. In one embodiment of the invention, various characteristics of the cleaved substrate are determined by the velocity and acceleration of the cleave front across the plane of the substrate, for example, surface finish. In one embodiment of the invention, cleave initiation and propagation can be performed in separate processes. Alternatively, the cleave initiation can be performed in conjunction with cleave propagation on, for example, the same piece of equipment.

Above, a process for non-contact cleaving is presented. In an alternate embodiment of the present invention, a contact cleaving process is used to initiate cleaving in a substrate. In one embodiment of the invention, striking the substrate with a blade, for example initiates cleaving in the substrate.

Process 1100 comprises step 1102, initiating a cleave in a substrate comprising a planar surface by striking along a portion of an edge of the substrate substantially parallel to the planar surface under tensile force. In one embodiment, a blade is struck against the edge of the substrate to initiate the cleave.

Step 1104 comprises propagating the cleave by controlling acceleration and velocity of the cleave across the planar surface, wherein propagating the cleave frees a portion of the substrate to be removed. In one embodiment of the invention, suction cups are used to provide a tensile force on the substrate during the cleaving.

Step 1106 comprises separating the substrate into layers by maintaining the applied tensile force, wherein after the substrate is cleaved, the layers do not touch. By not allowing the surfaces form contacting after cleaving, surface finish is greatly improved.

Embodiments of the present invention, an apparatus and method for cleaving have been described. While the present invention has been described in particular embodiments, it should be appreciated that the present invention should not be construed as limited by such embodiments, but rather construed according to the following Claims.

The foregoing descriptions of specific embodiments of the present invention have been presented for purposes of illustration and description. They are not intended to be exhaustive or to limit the invention to the precise forms disclosed. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1) A method for forming a thin film of material from a bonded substrate using a controlled cleaving process comprising:
applying a tensile force along both sides of a portion of an edge of said bonded substrate;
initiating a cleave within said bonded substrate by applying an additional force along said portion of said edge of said substrate assembly;
propagating said cleave by controlling said tensile force along said edge of said bonded substrate, wherein propagating said cleave frees a layer of said bonded substrate to be removed; and
separating said layer from said bonded substrate by applying said tensile force, wherein after said propagating, said layer of said bonded substrate to be removed does not touch said bonded substrate.

2) The method as described in claim 1 wherein said additional force is imparted by a static gas pressure developed between said edge of said bonded substrate and an o-ring along at least a portion of said bonded substrate circumference.

3) The method as described in claim 1 wherein an o-ring or suction cup provides a suction force to provide said tensile force used to separate said bonded substrate.

4) The method as described in claim 2 wherein a computer control module is used to control said static gas pressure.

5) The method as described in claim 2 wherein a burst of gas is used to provide said static gas pressure.

6) The method as described in claim 1 wherein said additional force is applied with a mechanical blade.

7) The method as described in claim 1 wherein an electrically controlled motor is used to separate said substrate assembly during cleaving.

8) A method of cleaving a bonded substrate comprising:
placing said bonded substrate on a first portion of a substrate cleaving shell;
placing said bonded substrate on a second portion of said substrate cleaving shell;
applying a tensile force along both sides of a portion of an edge of said bonded substrate;
initiating a cleave within said bonded substrate by applying an additional force along said portion of said edge of said bonded substrate;
propagating said cleave by controlling said tensile force along said edge of said bonded substrate, wherein propagating said cleave frees a portion of said bonded substrate to be removed; and
separating said portion of said bonded substrate to be removed from said substrate by maintaining said tensile force such that after said propagating, said portion of said bonded substrate to be removed does not touch said bonded substrate.

9) The method as described in claim 8 further comprising monitoring and controlling said initiating with a computer control module.

10) The method as described in claim 8 wherein said additional force is imparted by a static gas pressure developed between said edge of said bonded substrate and an o-ring along at least a portion of said bonded substrate circumference.

11) The method as described in claim 10 wherein said static gas pressure is pressurized nominally to about 300 to 3000 pounds per square inch.

12) The method as described in claim 8 wherein an electrically controlled motor is used to provide said tensile force by separating said cleaving shell.

13) An apparatus for controlled cleaving of a bonded substrate comprising:
a bottom shell coupled to a hinge mechanism;
a top shell coupled to said hinge mechanism;
a plurality of o-rings or suction cups coupled to said top and bottom shells for providing a suction force sufficient to exert a tensile force to a top and a bottom of said bonded substrate;
an initiating means for applying an additional force along a portion of an edge of said bonded substrate and for initiating a cleave in said bonded substrate; and
a height adjustment mechanism coupled to said top shell and said bottom shell for propagating said cleave by separating said top shell from said bottom shell.

14) The apparatus as described in claim 13 further comprising a computer control module for monitoring and adjusting said initiating means and said height adjustment mechanism.

15) The apparatus as described in claim 13 wherein said height adjustment mechanism provides said tensile force to said bonded substrate.

16) The apparatus as described in claim 15 wherein said tensile force prevents any portion of a cleaved layer from contacting said bonded substrate after cleaving of said portion is completed.

17) The apparatus as described in claim 13 wherein an electrically controlled motor is used to separate said top shell from said bottom shell.

18) The apparatus as described in claim 13 wherein said initiating means starts said propagating as a result of a substrate cleave action being detected.

19) The apparatus as described in claim 13 wherein a cleave position sensor and/or force sensor determines a position, a velocity and an acceleration of said cleave which is used to establish a separation profile.

20) The apparatus as described in claim 13 further comprising a sensor for monitoring a tensile force loss between said portion of said bonded substrate when an initiation cleave event has occurred to start said propagation of said cleave.

21) A method for controlling cleaving of a thin film of material from a bonded substrate comprising a planar surface comprising:
apply a tensile force on both side of said bonded substrate;
initiating a cleave in said bonded substrate by striking along a portion of an edge of said bonded substrate substantially parallel to said planar surface;
propagating said cleave by controlling acceleration and velocity of said cleave across said planar surface, wherein propagating said cleave frees a portion of said bonded substrate to be removed, and
separating said substrate into layers by maintaining said tensile force, wherein after said bonded substrate is cleaved, any portion of said cleaved layer does not touch said substrate.

22) The method as described in claim 21 wherein a plurality of O-rings or suction cups are used to apply said tensile force.

23) The method as described in claim 21 wherein a blade is used to initiate said cleave.

24) The method as described in claim 21 wherein a computer control module is used to control said acceleration and velocity of said cleave.

25) The method as described in claim 21 wherein an electrically controlled motor is used to control said acceleration and said velocity of said cleave.

26) The method as described in claim 25 wherein said electrically controlled motor is coupled to a hinge device for controlling said velocity and said acceleration of said cleave and for providing said tensile force for separating said layers.

27) An apparatus for controlling cleaving of layers from a bonded substrate comprising:
a bottom shell coupled to a hinge mechanism;
a top shell coupled to said hinge mechanism;
a plurality of compliant members coupled to said top and bottom shells for providing a suction force sufficient to exert a tensile force to a top and a bottom surface of a bonded substrate; and
an electrically controlled motor coupled to said hinge mechanism for controlling position, velocity and acceleration of a cleave front across said bonded substrate and for providing said tensile force wherein any portion of the separated layer does not touch said bonded substrate after said cleaving.

28) The apparatus as described in claim 27 further comprising a computer control module for monitoring and adjusting said electrically controlled motor.

29) The apparatus as described in claim 27 wherein said compliant member comprise an o-ring or suction cup.

30) The apparatus as described in claim 27 wherein said electrically controlled motor is a servo.

31) The apparatus as described in claim 27 wherein said electrically controlled motor is a stepper motor.

32) The apparatus as described in claim 27 wherein a cleave position sensor and/or force sensor determines said position, said velocity and said acceleration of said cleave which is used to establish a separation profile.
